(19) United States
(12) Patent Application Publication
(10) Pub. No.: US 2019/0239140 A1
(43) Pub. Date: Aug. 1, 2019

(54) WLAN PERFORMANCE WHILE COEXISTING WITH BLUETOOTH LOW ENERGY COMMUNICATIONS

(71) Applicant: Qualcomm Incorporated, San Diego, CA (US)

(72) Inventors: Gijo Georgekutty ARICKAN, Cupertino, CA (US); Wonho Park, San Diego, CA (US)

(21) Appl. No.: 15/884,141

(22) Filed: Jan. 30, 2018

(51) Int. Cl. H04W 40/16; H04W 4/80; H04W 24/08

(52) U.S. Cl. CPC H04W 40/16; H04W 84/12; H04W 24/08; H04W 4/80

(57) ABSTRACT

This disclosure provides systems, devices, apparatus and methods, including computer programs encoded on storage media, for wireless communication. In one aspect, a method for wireless communication can include determining, at a WLAN module of a first wireless device, a recommended BT usage parameter based on a minimum bandwidth requirement of the WLAN module; communicating, via a messaging interface of the first wireless device, the recommended BT usage parameter from the WLAN module to a (Bluetooth) BT module of the first wireless device; and slicing, at the BT module, a BT packet based on the recommended BT usage parameter.

### TECHNICAL FIELD

This disclosure relates generally to wireless communications, and more specifically, to systems and methods for improving the coexistence of WLAN and Bluetooth networks.

### DESCRIPTION OF THE RELATED TECHNOLOGY

Wireless communication systems are rapidly growing in usage. The recent proliferation of devices employing wireless communication technologies requires careful design to minimize interference and improve the quality of service. For example, wireless local area network (WLAN) and Bluetooth (BT) communication systems are often implemented in a single device.

WLAN is a popular intermediate range wireless communication standard. Most current WLANs are based on the IEEE 802.11 standard and are marketed under the Wi-Fi brand name. WLAN communication systems link one or more devices to a wireless access point, which in turn provides connectivity to the wider area Internet.

BT, including the BT Low Energy (BTLE) standard, is a popular short range wireless communication standard. BT communications are particularly popular for connecting wireless devices to various accessory devices, such as headsets, headphones, speakers, keyboards, mice, trackpads, styluses, remote controls, game controllers, wearable devices (e.g., smart watches or smart glasses), home automation devise, etc. BT may also be used to provide communications between wireless devices, such as to stream audio/video content for display from a mobile device to a smart television, digital media player, or other entertainment device; or to transfer user files or other data directly between wireless devices. BT allows for the creation of a personal area network (PAN) between a master and one or more slaves.

In particular, the BTLE standard has been designed for low power and low latency applications for wireless devices. BTLE devices can be found in a wide range of industries including healthcare, fitness, security, smart energy, industrial automation, and home entertainment. Further, BTLE technology is increasingly being used in new applications and environments. As compared to classic BT devices, BTLE devices consume significantly less power for communications and are able to initiate data transmission much more quickly than classic BT devices.

Although WLAN communications operate on an asynchronous protocol and access the wireless medium using Carrier Sense Multiple Access/Collision Avoidance (CSMA/CA) mechanisms while BT communications rely on time division multiplex access (TDMA) mechanisms, both share the 2.4 GHz Industrial, Scientific and Medical Device (ISM) band. As BT enabled accessories become increasingly prolific for use in communicating with Wi-Fi enabled wireless stations, congestion of this frequency band also increases. As a result, interference between the two communications systems can occur. This may lead to communications latency, as scheduling constraints and interference cause communications packets to be delayed or retransmitted.

Accordingly, a system and method for implementing WLAN and BT communications that minimizes interference is desired.

### SUMMARY

The systems, methods and devices of this disclosure each have several innovative aspects, no single one of which is solely responsible for the desirable attributes disclosed herein.

One innovative aspect of the subject matter described in this disclosure can be implemented in a method for wireless communication. In some implementations, the method can include determining, at a WLAN module of a first wireless device, a recommended BT usage parameter based on a minimum bandwidth requirement of the WLAN module; communicating, via a messaging interface of the first wireless device, the recommended BT usage parameter from the WLAN module to a (Bluetooth) BT module of the first wireless device; and slicing, at the BT module, a BT packet based on the recommended BT usage parameter.

In some implementations, the recommended BT usage parameter can include at least one of a BT packet duration and a BT protocol data unit (PDU) size. In some implementations, the BT packet can include a BT Low Energy (LE) long range coded physical layer (PHY) packet. In some implementations, the step of slicing a BT packet based on the BT usage parameter can further include slicing the BT packet into a plurality of smaller BT packets each having a PDU size appropriate for transmission within the recommended BT usage parameter.

In some implementations, the method can further include transmitting the recommended BT usage parameter to a second wireless device. In some implementations, the method can further include negotiating with the second wireless device to adjust at least one of a BT packet duration and a BT PDU size based on the recommended BT usage parameter. In some implementations, the method can further include determining the minimum bandwidth requirement of the WLAN module based on an activity level of traffic between the WLAN module and a second wireless device.

In some implementations, the method can further include adjusting the recommended BT usage parameter based on the activity level of traffic between the WLAN module and the second wireless device. In some implementations, during a connection establishment of the WLAN module with the second wireless device, the recommended BT usage parameter can include a BT packet duration that is shorter than a default BT packet duration of the BT module.

In some implementations, during at least one of a high activity level and a critical activity level of traffic between the WLAN module and the second wireless device, the recommended BT usage parameter can include a BT packet duration that is shorter than the default BT packet duration of the BT module. In some implementations, during a low activity level of traffic between the WLAN module and the second wireless device, the recommended BT usage parameter can include the default BT packet duration of the BT module.

In some implementations, the recommended BT usage parameter can include the default BT packet duration of the BT module when the WLAN module is idle. In some implementations, the recommended BT usage parameter can include the default BT packet duration of the BT module when the WLAN module is turned off. In some implementations, the default BT packet duration can be one of approximately 17 milliseconds and approximately 4.5 milliseconds.

Another innovative aspect of the subject matter described in this disclosure can be implemented in a wireless device. In some implementations, the wireless device can include a transceiver; a memory; and a processor communicatively coupled to the transceiver and the memory, the processor including: a Wireless Local Area Network (WLAN) module configured to determine a recommended BT usage parameter based on a WLAN minimum bandwidth requirement, a messaging interface configured to communicate the recommended BT usage parameter from the WLAN module to a Bluetooth (BT) module, and the Bluetooth (BT) module configured to slice a BT packet based on the recommended BT usage parameter.

In some implementations, the recommended BT usage parameter can include at least one of a BT packet duration and a BT protocol data unit (PDU) size. In some implementations, the BT packet can include a BT Low Energy (LE) long range coded physical layer (PHY) packet. In some implementations, the BT module can be configured to slice the BT packet into a plurality of smaller BT packets each having a PDU size appropriate for transmission within the recommended BT usage parameter. In some implementations, the BT module can be configured to transmit the recommended BT usage parameter to a second wireless device.

In some implementations, the BT module can be configured to negotiate with the second wireless device to limit at least one of a BT packet duration and a BT PDU size based on the recommended BT usage parameter. In some implementations, the WLAN module can be configured to determine the minimum bandwidth requirement based on an activity level of traffic between the WLAN module and a second wireless device. In some implementations, the WLAN module can be configured to adjust the recommended BT usage parameter based on the activity level of traffic between the WLAN module and the second wireless device.

In some implementations, during a connection establishment of the WLAN module with the second wireless device, the recommended BT usage parameter can include a BT packet duration that is shorter than a default BT packet duration of the BT module. In some implementations, during at least one of a high activity level and a critical activity level of traffic between the WLAN module and the second wireless device, the recommended BT usage parameter can include a BT packet duration that is shorter than the default BT packet duration of the BT module. In some implementations, during a low activity level of traffic between the WLAN module and the second wireless device, the recommended BT usage parameter can include the default BT packet duration of the BT module.

In some implementations, the recommended BT usage parameter can include the default BT packet duration of the BT module when the WLAN module is idle. In some implementations, the recommended BT usage parameter can include the default BT packet duration of the BT module when the WLAN module is turned off. In some implementations, the default BT packet duration can be one of approximately 17 milliseconds and approximately 4.5 milliseconds.

Another innovative aspect of the subject matter described in this disclosure can be implemented in an apparatus for wireless communication. In some implementations, the apparatus can include means for determining a recommended Bluetooth (BT) usage parameter based on a minimum bandwidth requirement of a Wireless Local Area Network (WLAN) module; means for communicating the recommended BT usage parameter from the WLAN module to a BT module; and means for slicing a BT packet based on the recommended BT usage parameter.

Another innovative aspect of the subject matter described in this disclosure can be implemented in a non-transitory computer-readable storage medium. In some implementations, the non-transitory computer-readable storage medium can include storing instructions that, when executed by one or more processors of a wireless communications device, cause the wireless communications device to: determine a recommended Bluetooth (BT) usage parameter based on a minimum bandwidth requirement of a Wireless Local Area Network (WLAN) module; communicate the recommended BT usage parameter from the WLAN module to a BT module; and slice a BT packet based on the recommended BT usage parameter.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 is a conceptual diagram illustrating an example of a wireless communication system in accordance with various aspects of the present disclosure.

FIG. 2 is a schematic diagram of a wireless device in accordance with various aspects of the present disclosure.

FIG. 3 is a chart illustrating different modulation and coding scheme (MCS) options for Bluetooth Low Energy in accordance with various aspects of the present disclosure.

FIG. 4 is a diagram illustrating a shared bandwidth for Wireless Local Area Network (WLAN) and Bluetooth (BT) communications in accordance with various aspects of the present disclosure.

FIG. 5 is another diagram illustrating a shared bandwidth for WLAN and BT communications in accordance with various aspects of the present disclosure.

FIG. 6 is a flow diagram illustrating an example of a method for wireless communications in accordance with various aspects of the present disclosure.

Like reference numerals refer to corresponding parts throughout the drawing figures.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. Systems and methods are disclosed for improving a quality of service of a wireless local area network (WLAN) that coexists with Bluetooth (BT) technology in a single wireless device, and more specifically, with BT Low Energy (BLE) communications.

For example, within the wireless device, a WLAN module may communicate to a BT module its minimum bandwidth requirement and recommend to the BT module a BT usage time between anchor points for transmitting and receiving BT packets. The communication between the WLAN module and the BT module may occur via a messaging interface in the wireless device. Upon receiving the recommended BT usage time, the BT module may slice the BT packets to a size that is appropriate for transmission within the BT usage time recommended by the WLAN module. For instance, in relation to BLE communications, each of the BT packets may comprise a long coded physical layer (PHY) packet.

According to the most recent BT specification, Bluetooth Core Specification v5.0, a Low Energy (LE) coded PHY packet may have a longer packet duration than a legacy LE 1 Megabit per second (1 Mb/s) PHY packet, or LE 1 M PHY packet. More specifically, LE coded PHY packets may now have up to a maximum packet duration of approximately 17 milliseconds and a maximum PDU size of 257 Octets. These long coded PHY packets are used for long range transmission and reception with a second wireless device.

In addition, the long coded PHY packets repeat a same bit content either 2 times or 8 times to achieve communication over a long distance between the two wireless devices. Therefore, when the BT module slices the long coded PHY packets to a smaller size based on the BT usage time recommended by the WLAN module, BLE long range operation and packet transmission/reception may remain unaffected. As such, the wireless device may have more bandwidth between BT anchor points for WLAN operation.

For instance, the WLAN module may limit the BT usage time to the BT module during high and/or critical levels of WLAN traffic, such as during connection establishment with an Access Point (AP), streaming high definition video data, etc. During low levels of WLAN traffic, the WLAN module may recommend a larger BT usage time to the BT module. When WLAN is idle or turned off, the WLAN module may also recommend a default or preferred BT usage time of the BT module. This flexible approach may enable the wireless device to more accurately meet quality of service requirement of both WLAN and BT.

By having the WLAN module recommend the BT transmission/reception window duration, improved WLAN performance may be achieved while coexisting with BLE utilization of long coded PHY packets. Furthermore, a more reliable BT data delivery may be ensured during a BT and WLAN interference scenario. Due to its larger size, the long coded PHY packets may have a higher chance of experiencing interference and subsequent delay or retransmission. As a result, slicing the long coded PHY packets when there is increased WLAN traffic may minimize interference between BT and WLAN, while also improving BT performance. Different features and variations can be implanted, as desired, and related systems and methods can be utilized as well.

Various aspects of the novel systems, apparatuses, computer-readable media, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, computer-readable media, and methods disclosed herein, whether implemented independently of, or combined with, any other aspect of the features described. For example, an apparatus may be implemented or a method may be practiced using any number of the aspects set forth herein. In addition, the scope of the disclosure is intended to cover such an apparatus or method, which is practiced using other structure, functionality, or structure and functionality in addition to or other than the various aspects of the disclosure set forth herein. It should be understood that any aspect disclosed herein may be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

Various configurations are described with reference to the Figures, where like reference numbers may indicate functionally similar elements. The systems and methods as generally described and illustrated in the Figures could be arranged and designed in a wide variety of different configurations. Thus, the following more detailed description of several configurations, as represented in the Figures, is not intended to limit scope, but is merely representative.

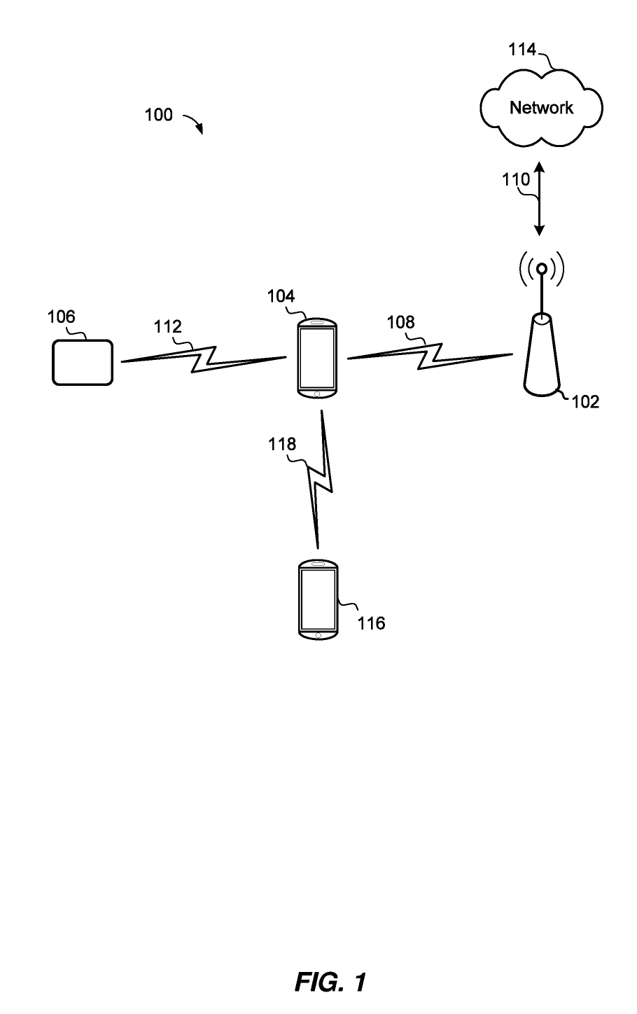

FIG. 1 shows an example wireless communication system 100 in which aspects of the present disclosure may be employed. Wireless communication systems are widely deployed to provide various types of communication content, such as voice, data, and so on. Communications in the wireless communication system 100 may be achieved through transmissions over a wireless link. Such a wireless link may be established via a single-input and single-output (SISO), multiple-input and single-output (MISO) or a multiple-input and multiple-output (MIMO) system. A MIMO system includes transmitter(s) and receiver(s) equipped, respectively, with multiple (NT) transmit antennas and multiple (NR) receive antennas for data transmission. In some configurations, the wireless communication system 100 may utilize MIMO. A MIMO system may support time division duplex (TDD) and/or frequency division duplex (FDD) systems.

The wireless communication system 100 may be implemented in any device, system, or network that is capable of transmitting and receiving RF signals according to one or more standards, such as any of the Institute of Electrical and Electronics Engineers (IEEE) 802.11 (Wi-Fi) standards, the Bluetooth standard IEEE 802.15.1, Bluetooth Low Energy (BLE), Worldwide Interoperability for Microwave Access (WiMAX) IEEE 802.16, code division multiple access (CDMA), frequency division multiple access (FDMA), orthogonal frequency division multiple access (OFDMA), time division multiple access (TDMA), single-carrier frequency division multiple access (SC-FDMA), Global System for Mobile communications (GSM), General Packet Radio Service (GPRS), Enhanced Data GSM Environment (EDGE), Universal Mobile Telecommunications System (UMTS), Terrestrial Trunked Radio (TETRA), Wideband-CDMA (W-CDMA), CDMA2000, Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless, cellular or internet of things (IoT) network, such as a system utilizing 3G, 4G, or 5G, or further implementations thereof, technology.

In an aspect, the wireless communication system 100 may have both wireless local area network (WLAN) and Bluetooth communication capabilities and may include various wireless devices 102, 104, 106, and 116. For example, the wireless devices may include one or more access points (AP) 102, one or more clients or stations (STA) 104, 116 and one or more accessory devices 106. In this example, the STA 104 may be configured to communicate over a wireless communication channel 108 with the AP 102. The AP 102 may be configured to communicate via a wired or wireless communication channel 110 with a network 114, such as the Internet. The STA 104 may also be configured to communicate with one or more STAs, such as STA 116. The STA 104 may communicate with the STA 116 over a wireless communication channel 118, such as in a peer-to-peer (P2P), Soft AP (SAP), independent basic service set (IBSS), Neighborhood Area Network, or other connection. Continuing the example, the accessory device 106 may be configured to communicate over a wireless communication channel 112 with the STA 104.

The AP 102 may serve as a hub or base station for the WLAN, and the STA 104 may serve as a user of the WLAN. For example, the STA 104 may be a laptop computer, a personal digital assistant (PDA), a mobile phone, etc. In an example, the STA 104 connects to the AP 102 via a Wi-Fi (such as the IEEE 802.11 protocol) compliant wireless link to obtain general connectivity to the Internet or to other wide area networks. In some implementations, the STA 104 and/or the STA 116 may also be used as an AP.

The AP 102 may also include, be implemented as, or known as a NodeB, Radio Network Controller (RNC), eNodeB, Base Station Controller (BSC), Base Transceiver Station (BTS), Base Station (BS), Transceiver Function (TF), Radio Router, Radio Transceiver, connection point, or some other terminology.

The STA 104 and the STA 116 may also include, be implemented as, or known as an access terminal (AT), a subscriber station, a subscriber unit, a mobile station, a remote station, a remote terminal, a user terminal, a user agent, a user device, a user equipment, or some other terminology. In some implementations, the STA 104 may include a cellular telephone, a cordless telephone, a Session Initiation Protocol (SIP) phone, a wireless local loop (WLL) station, a personal digital assistant (PDA), a handheld device having wireless connection capability, or some other suitable processing device connected to a wireless modem. Accordingly, one or more aspects taught herein may be incorporated into a phone (such as a cellular phone or smartphone), a computer (such as a laptop), a portable communication device, a headset, a portable computing device (such as a personal data assistant), an entertainment device (such as a music or video device, or a satellite radio), a gaming device or system, a global positioning system device, or any other suitable device that is configured to communicate via a wireless medium.

The accessory device 106 may be configured to communicate with a wireless device using a short or medium range wireless communication protocol to enhance the capabilities of the wireless device. The accessory device 106 may communicate with a wireless device using any of various communication protocols, such as Wi-Fi or Bluetooth. Examples of accessory devices may include wireless headsets, headphones, speakers, keyboards, keypads, mice, trackpads, styluses, remote controllers, game controllers, wearable devices (e.g., smart watches or smart glasses), sensors, routers, meters, home automation devices (e.g., light control switches, dimmers, thermostats, security cameras, media players, etc.), medical devices, internet of things (IoT) devices, etc. In some implementations, the accessory device 106 may also be a STA and/or an AP.

In an example, the accessory device 106 may be configured to communicate with the STA 104 using Bluetooth, including Bluetooth Low Energy (BLE) protocols. The Bluetooth wireless communication standard is typically employed for exchanging communications between fixed or mobile Bluetooth-enabled devices over short distances. In some configurations, the systems and methods disclosed herein may be applied to establishing connections between Bluetooth-enabled devices configured to operate according to BLE standards. LE refers to the “Low Energy” extension of the Bluetooth standard. The BLE extension is focused on energy-constrained applications, such as battery-operated devices, sensor applications, etc. A BLE device may comprise a transmitter, a receiver, or both, and may use a frequency-hopping transceiver to combat interference and fading. Although terminology associated with the Bluetooth and BLE standards may be used, the concepts are applicable to other technologies and standards that involve modulating and transmitting digital data.

BLE systems operate in the unlicensed 2.4 gigahertz (GHz) Industrial, Scientific, and Medical (ISM) band. The 2.4 GHz unlicensed band has many technologies that operate simultaneously. For example, WLAN operates in the unlicensed 2.4 GHz ISM band as well. As discussed above, there is a need to provide systems and methods that allow efficient coexistence of WLAN and Bluetooth communication systems, particularly BLE systems, within a single device.

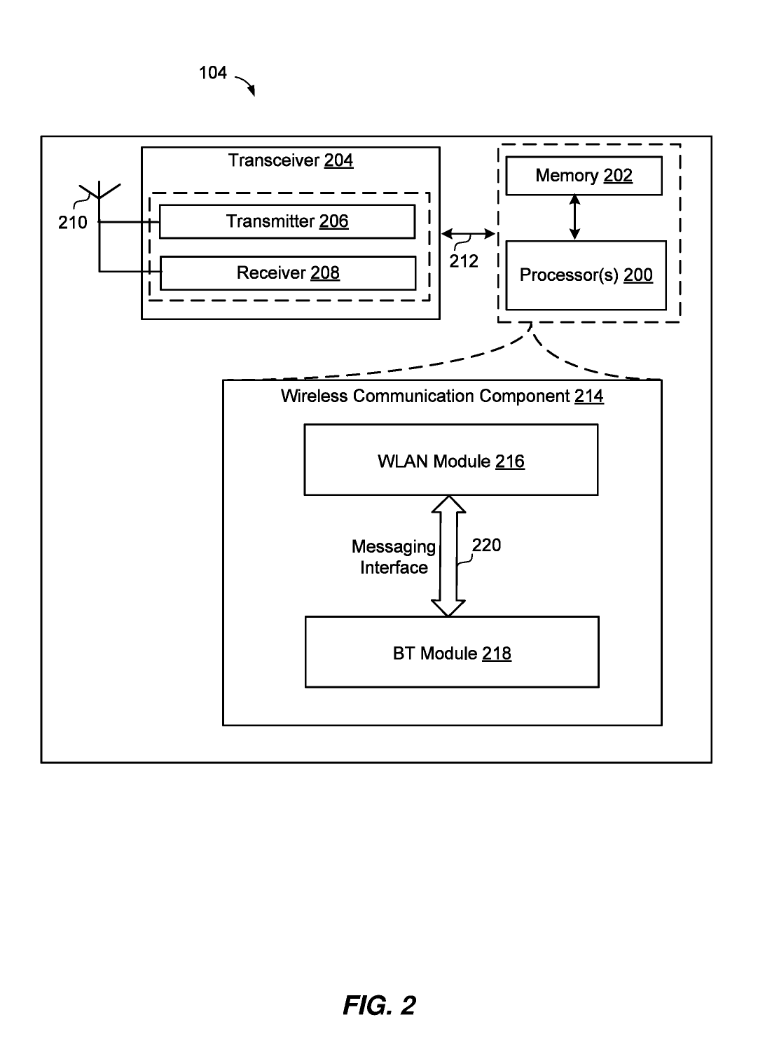

FIG. 2 is a diagram of a single wireless device, such as the STA 104, having both WLAN and Bluetooth communication capabilities. In some implementations, the AP 102, the accessory device 106, and/or the STA 116 may have a same or similar architecture as the STA 104 shown in FIG. 2. The STA 104 may include one or more processors 200, one or more memories 202, and one or more transceivers 204. The processor 200 may control operation of the STA 104. The processor 200 may also be referred to as a central processing unit (CPU). The memory 202 may provide instructions and data to the processor 200. The memory 202 can include any type of computer-readable medium usable by a computer or processor 200, such as random access memory (RAM), read only memory (ROM), tapes, magnetic discs, optical discs, volatile memory, non-volatile memory, and any combination thereof. A portion of the memory 202 may also include non-volatile random access memory (NVRAM). The processor 200 typically performs logical and arithmetic operations based on program instructions stored within the memory 202. The instructions in the memory 202 may be executable, such as by the processor 200, to implement the methods described herein.

The processor 200 may include or be a component of a processing system implemented with one or more processors. The one or more processors may be implemented with any combination of general-purpose microprocessors, microcontrollers, DSPs, FGPAs, PLDs, modem processors, baseband processors, transmit processors, controllers, state machines, gated logic, discrete hardware components, dedicated hardware finite state machines, or any other suitable entities that can perform calculations or other manipulations of information.

The processing system may include an interface configured to provide information for transmission by the transceiver 204. The interface may also be configured to receive information from the transceiver 204. In an aspect, the interface may be an interface of the processor 200.

The processing system may also include machine-readable media for storing software. Software shall be construed broadly to mean any type of instructions, whether referred to as software, firmware, middleware, microcode, hardware description language, or otherwise. Instructions may include code (such as in source code format, binary code format, executable code format, or any other suitable format of code). The instructions, when executed by the one or more processors, cause the processing system to perform the various functions described herein.

The transceiver 204 may include a transmitter 206 and a receiver 208 to allow transmission and reception of data between the STA 104 and other wireless devices. The transmitter 206 may include one or more components that form a transmitting chain, and the receiver 208 may include one or more components that form a receiving chain. The transmitter 206 and the receiver 208 may be combined into the transceiver 204. The transceiver 204 may comprise hardware, firmware, and/or software and may be configured to execute code or perform instructions stored in a memory, such as in the memory 202. The transceiver 204 may include multiple radios and modems. The STA 104 and the transceiver 204 may enable multiple wireless connections, such as a WLAN and a Bluetooth connection, with one or more wireless devices. An antenna 210 may be electrically coupled to the transceiver 204. The antenna 210 may transmit signals to and receive signals from other wireless devices. The STA 104 may also include multiple transmitters, multiple receivers, multiple transceivers, and/or multiple antennas.

The processor 200, the memory 202, and the transceiver 204 may communicate internally via a bus 212. In some examples, the processor 200 and the memory 202 may be part of the same hardware component (e.g., may be part of a same board, module, or integrated circuit). Alternatively, the processor 200 and the memory 202 may be separate components that may act in conjunction with one another. The bus 212 may be a communication system that transfers data between multiple components and subcomponents of the STA 104.

In an aspect, the processor 200 may include a wireless communication component 214 for carrying out one or more methods or procedures described herein. The wireless communication component 214 may include a WLAN module 216, a Bluetooth (BT) module 218, and a messaging interface 220 communicatively coupled to the WLAN module 216 and the BT module 218. Each of the wireless communication component 214, the WLAN module 216, the BT module 218, and the messaging interface 220 may comprise hardware, firmware, and/or software and may be configured to execute code or perform instructions stored in a memory, such as the memory 202, or other computer-readable storage medium. The memory 202 may be a computer-readable storage medium, such as a non-transitory medium, that stores computer-executable code. The computer-executable code may define one or more operations or functions of the wireless communication component 214 and/or one or more of its subcomponents, and/or data associated therewith. The computer-executable code may define these one or more operations or functions when the STA 104 is operating the processor 200 to execute the wireless communication component 214 and/or one or more of its subcomponents.

The WLAN module 216 may be configured to operate WLAN communications of the STA 104, such as according to the IEEE 802.11 Wi-Fi standards. The BT module 218 may be configured to operate BT communications of the STA 104, such as according to the IEEE 802.15.1 BT and BLE standards. The messaging interface 220 may be configured to connect the WLAN module 216 and the BT module 218. The messaging interface 220 may pass data and information between the WLAN module 216 and the BT module 218. For example, a hardware portion of the messaging interface 220 may connect a hardware portion of the WLAN module 216 to a hardware portion of the BT module 218. Continuing the example, a software portion of the messaging interface 220 may be configured to communicate information between a software portion of the WLAN module 216 and a software portion of the BT module 218. However, other configurations for the messaging interface 220 may be used.

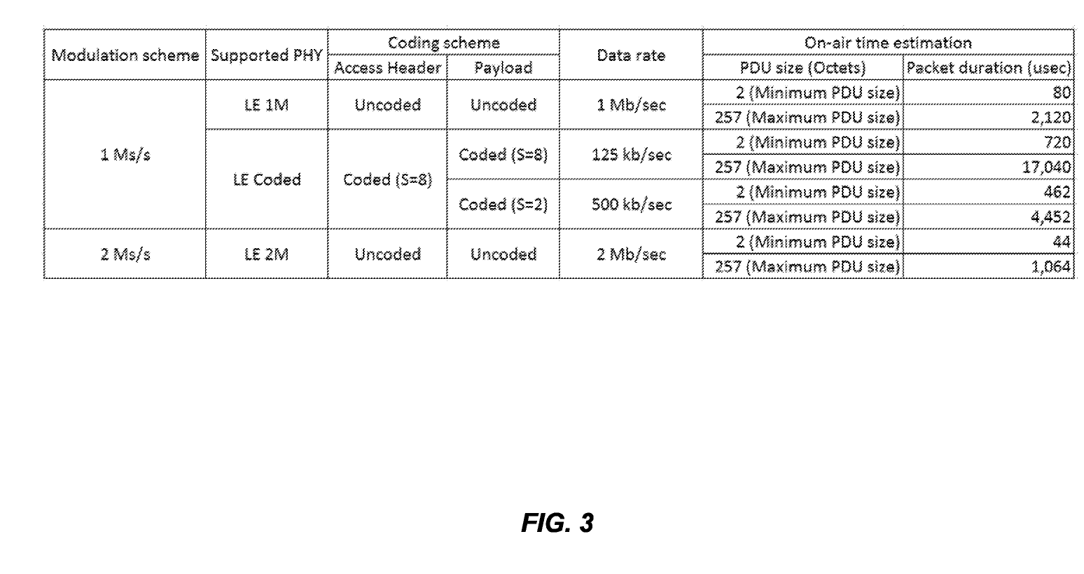

FIG. 3 is a chart illustrating, in an aspect, different modulation and coding scheme (MCS) options for BLE long range coded physical layer (PHY) packets, in accordance with Bluetooth Core Specification v5.0. A legacy, uncoded Low Energy (LE) 1 Megabit per second (1 Mb/s) PHY packet, or LE 1 M PHY packet, may have a minimum packet duration of approximately 80 microseconds and a minimum protocol data unit (PDU) size of 2 Octets. The LE 1 M PHY packet may have a maximum packet duration of approximately 2.1 milliseconds and a maximum PDU size of 257 Octets. An uncoded LE 2 Mb/s PHY packet, or LE 2 M PHY packet, may have a minimum packet duration of approximately 44 microseconds and a minimum PDU size of 2 Octets. The LE 2 M PHY packet may have a maximum packet duration of approximately 1 millisecond and a maximum PDU size of 257 Octets.

An LE coded PHY packet may have a longer packet duration than the legacy LE 1 M PHY packet. LE coded PHY packets may be used for long range transmission and reception with an accessory device or other wireless device, such as another STA. LE long range coded PHY packets may include an LE coded 2 symbols per bit (S=2) PHY packet and an LE coded 8 symbols per bit (S=8) PHY packet. For the LE coded (S=2) PHY packet, the data rate may be 500 kilobits per second (kb/s). A same bit content of the LE coded (S=2) PHY packet may be repeated 2 times to achieve communication over a long distance between the two wireless devices. The LE coded (S=2) PHY packet may have a minimum packet duration of approximately 462 microseconds and a minimum PDU size of 2 Octets. The LE coded (S=2) PHY packet may have a maximum packet duration of approximately 4.5 milliseconds and a maximum PDU size of 257 Octets.

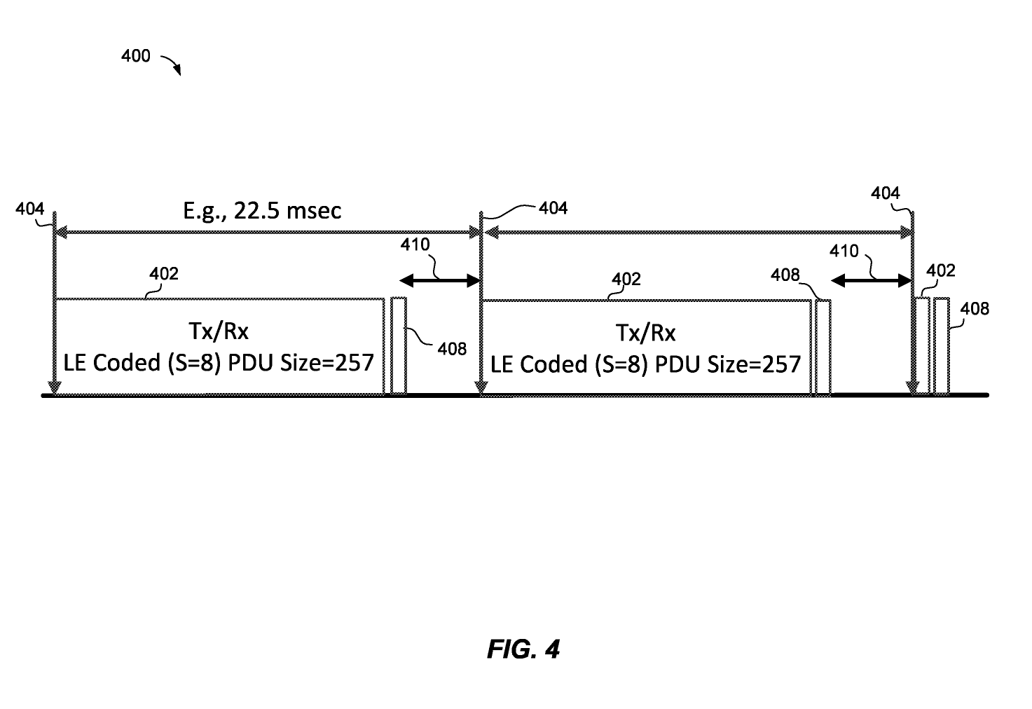

For an LE coded (S=8) PHY packet, the data rate may be 125 kb/s. A same bit content of the LE coded (S=8) PHY packet may be repeated 8 times to achieve communication over a long distance between the two wireless devices. The LE coded (S=8) PHY packet may have a minimum packet duration of approximately 720 microseconds and a minimum PDU size of 2 Octets. The LE coded (S=8) PHY packet may have a maximum packet duration of approximately 17 milliseconds and a maximum PDU size of 257 Octets. Thus, LE long range coded PHY packets may cover a significant portion (or up to an entirety) of a bandwidth, thereby leaving little (to zero) bandwidth for WLAN traffic, as illustrated in FIG. 4.

FIG. 4 illustrates, in an aspect, an example timing diagram 400 for the STA 104 using LE long range coded PHY packets 402. As shown in the example timing diagram 400, anchor points 404 may be set every 22.5 milliseconds. Therefore, a duration of a bandwidth for both BT traffic and WLAN traffic may be 22.5 milliseconds. In the example timing diagram 400, the LE long range coded PHY packets 402 are LE coded (S=8) PHY packets. As such, at every anchor point 404, a BT transmission/reception (Tx/Rx) window may include transmission or reception of an LE coded (S=8) PHY packet having a maximum packet duration of approximately 17 milliseconds. Each BT Tx/Rx window may also include reception or transmission of an acknowledgement packet 408.

If the maximum packet duration of approximately 17 milliseconds is used for the LE coded (S=8) PHY packet during the 22.5 milliseconds bandwidth, then less than 5.5 milliseconds are left for a WLAN operation window 410 between each anchor point 404. This may possibly cause poor performance and disconnection for WLAN traffic with the STA 104. It is to be understood that the numerical values of the timing diagram 400 are for example purposes only, and that various numerical values for the anchor points 404, bandwidth, packet duration, and WLAN operation windows 410 may be used. In addition, different types of LE long range coded PHY packets 402 may be used other than LE coded (S=8) PHY packets.

In another aspect, the LE long range coded PHY packets 402 may be sliced in order to increase a duration of the WLAN operation window 410 and improve WLAN traffic with the STA 104. More specifically, the LE long range coded PHY packets 402 may be sliced into a plurality of smaller packets for transmission at different anchor points based on a recommendation by the WLAN module 216. For instance, the WLAN module 216 may communicate, via the messaging interface 220, a recommended BT usage parameter to the BT module 218 in order to decrease the packet duration and/or the PDU size of the LE long range coded PHY packets 402, and thereby decrease a duration of the BT Tx/Rx window. The BT usage parameter may comprise a BT packet duration and/or a BT PDU size recommended by the WLAN module 216 to ensure WLAN traffic has sufficient bandwidth for the WLAN operation window 410. The BT module 218 may transmit the recommended BT usage parameter to the accessory device 106 and/or may negotiate a new packet duration and/or a new PDU size with the accessory device 106. In so doing, the BT module 218 and the accessory device 106 may slice its packets to a size appropriate for transmission within the recommended BT usage parameter.

The WLAN module 216 may determine the recommended BT usage parameter based on a minimum WLAN bandwidth requirement. The minimum WLAN bandwidth requirement may depend on WLAN traffic, such as between the STA 104 and the AP 102 and/or between the STA 104 and the STA 116. The WLAN module 216 may determine an activity level of the WLAN traffic and the minimum WLAN bandwidth requirement for the determined activity level. In one example, The WLAN module 216 may monitor throughput. If the throughput is above a predetermined threshold, then the WLAN module 216 may detect a high activity level of WLAN traffic. For instance, high activity levels of WLAN traffic may occur when streaming high definition video data, etc. In another example, the WLAN module 216 may monitor the type of frames for WLAN Tx/Rx. If the specific WLAN frame(s) need to be prioritized, such as an association request, an association response, etc. for connection establishment or other critical WLAN Tx/Rx periods, then the WLAN module 216 may detect a critical activity level of WLAN traffic. However, other ways to determine the minimum WLAN bandwidth requirement may be used, and other parameters may be monitored.

If there is a high and/or critical activity level of WLAN traffic, then the minimum WLAN bandwidth requirement may require significant bandwidth for the WLAN operation window 410. Therefore, the WLAN module 216 may recommend the BT usage parameter to be a BT packet duration that is shorter than a default BT packet duration and/or a BT PDU size that is smaller than a default BT PDU size. The default BT packet duration and the default BT PDU size may be a BT packet duration and a BT PDU size originally established during BT connection setup between the BT module 218 of the STA 104 and the accessory device 106. For instance, during high and/or critical activity levels of WLAN traffic, the recommended BT usage parameter may be the minimum BT packet duration and/or the minimum BT PDU size. The messaging interface 220 may communicate the recommended BT usage parameter to the BT module 218, which may then adjust a duration and/or a PDU size of BT packets to be within the recommended BT usage parameter.

More specifically, the BT module 218 of the STA 104 may transmit the recommended BT usage parameter to the accessory device 106 and/or may negotiate and establish with the accessory device 106 a shorter packet duration and/or a smaller packet size for BT packets within the recommended BT usage parameter, such as via a link layer length request (LL_LENGTH_REQ) and a link layer length response (LL_LENGTH_RSP). Furthermore, the BT module 218 and the accessory device 106 may slice a single LE long range coded PHY packet into a plurality of smaller packets, each having a size within the recommended BT usage parameter. Each smaller packet may be transmitted or received at different anchor points. In so doing, the WLAN operation window may have sufficient bandwidth during high and/or critical activity levels of WLAN traffic.

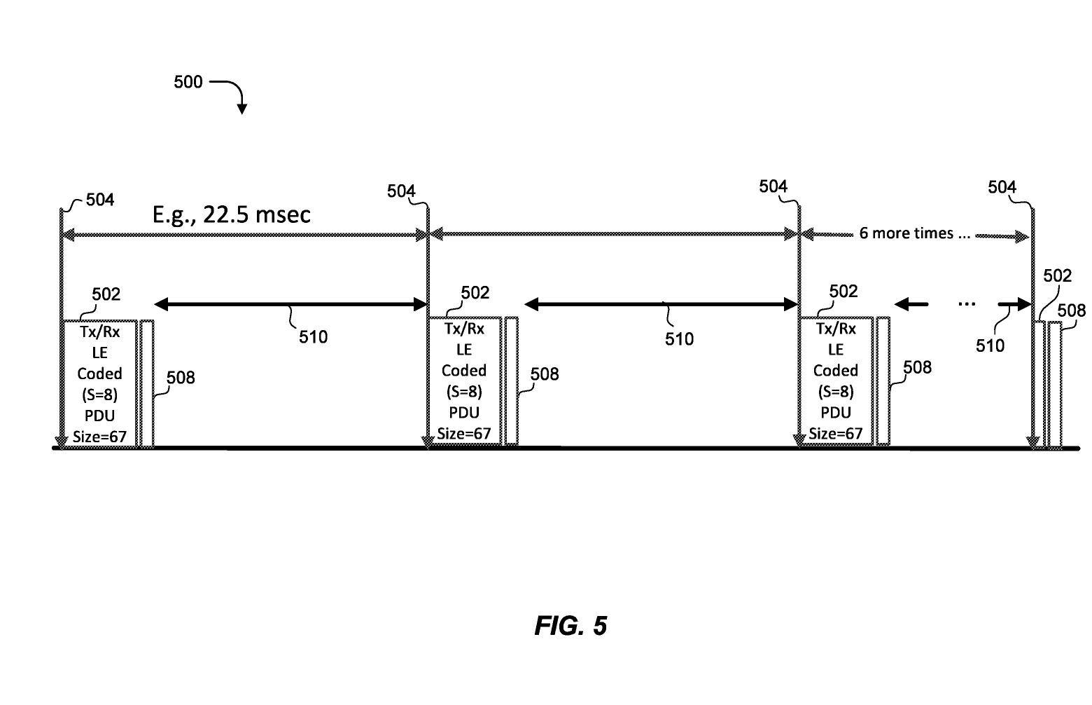

FIG. 5 illustrates, in an aspect, an example timing diagram 500 for the STA 104 using sliced LE long range coded PHY packets 502. In the example timing diagram 500, each sliced packet 502 is about a quarter of a PDU size, a bit content, and a packet duration of the LE long range coded PHY packets 402 in the example timing diagram 400 of FIG. 4. The example timing diagram 500 illustrates an effect of slicing each of the LE long range coded PHY packets 402 into a plurality of smaller packets 502, such as into four smaller packets, based on the recommended BT usage parameter from the WLAN module 216. At each anchor point 504, one of the sliced packets 502 may be transmitted to or received from the accessory device 106, and an acknowledgement packet 408 may be subsequently received from or transmitted to the accessory device 106.

A duration of each BT Tx/Rx window is substantially decreased using the sliced packets 502, thereby allowing each WLAN operation window 510 sufficient bandwidth during high and/or critical activity levels of WLAN traffic. For instance, if each sliced packet 502 has a packet duration of approximately 4.25 milliseconds, then about 18 milliseconds of the 22.5 millisecond bandwidth may be used for WLAN traffic. As a result, this may significantly improve WLAN throughput and quality of service. Furthermore, BT throughput and quality of service may also be improved using the sliced packets 502 during high activity levels of WLAN traffic because the sliced packets 502 have a lower chance of getting hit by interference with WLAN traffic due to their smaller size, as compared to the larger size of the LE long range coded PHY packets.

Since the bit content is repeated multiple times in LE long range coded PHY packets, slicing of these packets does not affect a long range operation of the BT module 218. It is to be understood that the numerical values of the timing diagram 500 are for example purposes only, and that various numerical values for the anchor points 504, bandwidth, packet duration, and WLAN operation windows 510 may be used. In addition, the LE long range coded PHY packets 402 may be sliced in different ways other than into four smaller packets 502.

In another aspect, the WLAN module 216 may adjust the recommended BT usage parameter based on the minimum bandwidth requirement of the WLAN module 216. The WLAN module 216 may continuously monitor the activity level of WLAN traffic. In high and/or critical activity levels of WLAN traffic, the recommended BT usage parameter may be the minimum BT packet duration and/or the minimum BT PDU size, for example, because the minimum bandwidth requirement during high and/or critical activity levels of WLAN traffic is significant. In zero to low activity levels of WLAN traffic, the recommended BT usage parameter may be the default BT packet duration and/or the default BT PDU size, for example, because the minimum bandwidth requirement during zero to low activity levels of WLAN traffic is insignificant. However, other values than the minimum or default values for the recommended BT usage parameter may be used.

For example, the WLAN module 216 may detect a low activity level of WLAN traffic if the throughput is below the predetermined threshold. The WLAN module 216 may also determine that there is no WLAN traffic or a zero activity level, such as when the WLAN module 216 is idle or turned off. During zero or low activity levels of WLAN traffic, the minimum WLAN bandwidth requirement may not require significant bandwidth for the WLAN operation window 410. Therefore, the WLAN module 216 may recommend the BT usage parameter to be the default BT packet duration and/or the default BT PDU size. In one example, the default BT packet duration and the default BT PDU size may be the maximum packet duration and the maximum PDU size, respectively, for any of the LE long range coded PHY packets. However, other default values may be used.

The messaging interface 220 may communicate the recommended BT usage parameter from the WLAN module 216 to the BT module 218, which may then adjust a size of BT packets to be within the recommended BT usage parameter. During low activity levels of WLAN traffic or when the WLAN module 216 is idle or turned off, the BT module 218 may transmit the BT usage parameter, such as the default BT packet duration and/or the default BT PDU size, to the accessory device 106. The BT module 218 may negotiate and establish with the accessory device 106 to use the default BT packet duration and/or the default BT PDU size for BT packets, such as via the link layer length request (LL_LENGTH_REQ) and the link layer length response (LL_LENGTH_RSP). Accordingly, the BT module 218 and the accessory device 106 may revert to using the LE long range coded PHY packets, such as in the example timing diagram 400 of FIG. 4. In so doing, the BT module 218 may use a significant duration of the bandwidth for the BT Tx/Rx window, leaving a small WLAN operation window 410 for the zero to low activity levels of WLAN traffic.

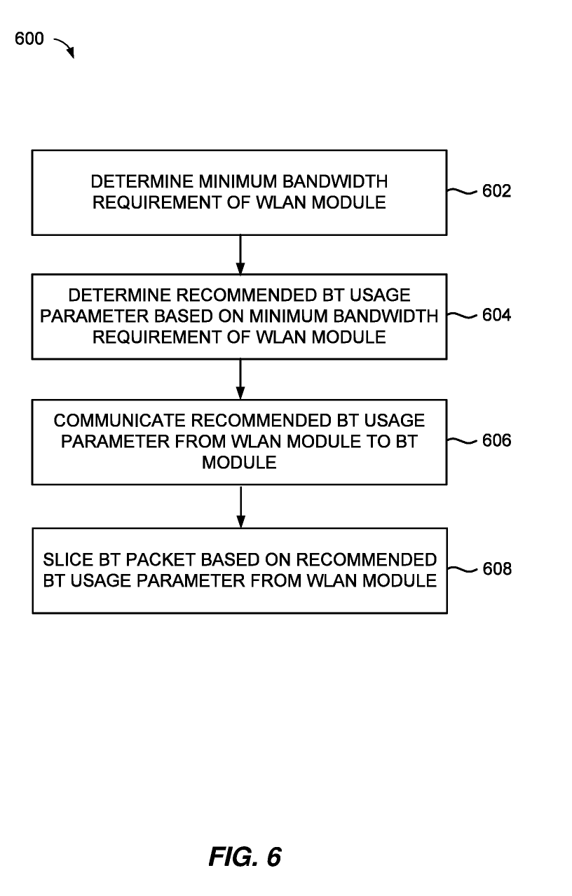

Referring to FIG. 6, an example of one or more operations related to the wireless communication component 214 (FIG. 2) according to the present apparatus and methods are described with reference to one or more methods and one or more components. Although the operations described below are presented in a particular order and/or as being performed by an example component, it should be understood that the ordering of the actions and the components performing the actions may be varied, depending on the implementation. Also, although the wireless communication component 214 is illustrated as having a number of subcomponents, it should be understood that one or more of the illustrated subcomponents may be separate from, but in communication with, the wireless communication component 214 and/or each other. Moreover, it should be understood that the following actions or components described with respect to the wireless communication component 214 and/or its subcomponents may be performed by one or more specially-programmed processors, processors executing specially-programmed software or computer-readable media, or by any other combination of one or more hardware components and/or software components specially configured for performing the described actions or components. For example, various aspects of the operation of the wireless communication component 214 and/or its subcomponents may be performed by, or implemented in, the processor 200 in FIG. 2.

In FIG. 6, a flow diagram is shown illustrating a method 600 for improving WLAN performance while BLE is using long range coded PHY packets. At block 602, a STA, such as the STA 104, may determine a minimum bandwidth requirement of a WLAN module, such as the WLAN module 216. The minimum bandwidth requirement of the WLAN module may depend on a throughput and/or an activity level of WLAN traffic. In another aspect, the wireless communication component 214, the WLAN module 216, and/or the processor 200 may determine the minimum bandwidth requirement of the WLAN module.

At block 604, the STA, such as the STA 104, may determine a recommended BT usage parameter based on the minimum bandwidth requirement of the WLAN module. If the minimum bandwidth requirement of the WLAN module is significant, such as during high and/or critical activity levels of WLAN traffic, then the recommended BT usage parameter may be a minimum BT packet duration and/or a minimum BT PDU size in order to shorten a BT Tx/Rx window and allow for a longer WLAN operation window. In an aspect, the wireless communication component 214, the WLAN module 216, and/or the processor 200 may determine the recommended BT usage parameter based on the minimum bandwidth requirement of the WLAN module.

At block 606, the STA, such as the STA 104, may communicate the recommended BT usage parameter from the WLAN module to a BT module, such as the BT module 218. In an aspect, the wireless communication component 214, the messaging interface 220, and/or the processor 200 may communicate the recommended BT usage parameter from the WLAN module to the BT module.

At block 608, the STA, such as the STA 104, may slice a BT packet based on the recommended BT usage parameter. The BT packet may comprise a BLE long range coded PHY packet. The STA may slice the BT packet into a plurality of smaller BT packets, each having a packet duration and/or a PDU size appropriate for transmission within the recommended BT usage parameter. With the smaller BT packets, the BT Tx/Rx window may be shortened, thereby allowing for the longer WLAN operation window. In an aspect, the wireless communication component 214, the BT module 218, and/or the processor 200 may slice the BT packet based on the recommended BT usage parameter.

The various operations of methods described above may be performed by any suitable means capable of performing the operations, such as various hardware or software component(s), circuits, or component(s). Generally, any operations illustrated in the Figures may be performed by corresponding functional means capable of performing the operations.

In some aspects, an apparatus or any component of an apparatus may be configured to (or operable to or adapted to) provide functionality as taught herein. This may be achieved, for example: by manufacturing (e.g., fabricating) the apparatus or component so that it will provide the functionality; by programming the apparatus or component so that it will provide the functionality; or through the use of some other suitable implementation technique. As one example, an integrated circuit may be fabricated to provide the requisite functionality. As another example, an integrated circuit may be fabricated to support the requisite functionality and then configured (e.g., via programming) to provide the requisite functionality. As yet another example, a processor circuit may execute code to provide the requisite functionality.

It should be understood that any reference to an element herein using a designation such as “first,” “second,” and so forth does not generally limit the quantity or order of those elements. Rather, these designations may be used herein as a convenient method of distinguishing between two or more elements or instances of an element. Thus, a reference to first and second elements does not mean that only two elements may be employed there or that the first element must precede the second element in some manner. Also, unless stated otherwise a set of elements may comprise one or more elements. In addition, terminology of the form “at least one of A, B, or C” or “one or more of A, B, or C” or “at least one of the group consisting of A, B, and C” used in the description or the claims means “A or B or C or any combination of these elements.” For example, this terminology may include A, or B, or C, or A and B, or A and C, or A and B and C, or 2A, or 2B, or 2C, and so on.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The methods, sequences and/or algorithms described in connection with the aspects disclosed herein may be embodied directly in hardware, in a software module executed by a processor, or in a combination of the two. The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of; data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, flash memory, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Accordingly, an aspect of the disclosure can include a non-transitory computer-readable storage medium embodying a method for wireless communications. Accordingly, the disclosure is not limited to the illustrated examples.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f), unless the element is expressly recited using the phrase “means for” or, in the case of a method claim, the element is recited using the phrase “step for.”

What is claimed is:

1. A method for wireless communication, comprising:
determining, at a WLAN module of a first wireless device, a recommended BT usage parameter based on a minimum bandwidth requirement of the WLAN module;
communicating, via a messaging interface of the first wireless device, the recommended BT usage parameter from the WLAN module to a (Bluetooth) BT module of the first wireless device; and
slicing, at the BT module, a BT packet based on the recommended BT usage parameter.

2. The method of claim 1, wherein the recommended BT usage parameter comprises at least one of a BT packet duration and a BT protocol data unit (PDU) size.

3. The method of claim 1, wherein the BT packet comprises a BT Low Energy (LE) long range coded physical layer (PHY) packet.

4. The method of claim 1, wherein the step of slicing a BT packet based on the BT usage parameter further comprises slicing the BT packet into a plurality of smaller BT packets each having a PDU size appropriate for transmission within the recommended BT usage parameter.

5. The method of claim 1, further comprising transmitting the recommended BT usage parameter to a second wireless device.

6. The method of claim 5, further comprising negotiating with the second wireless device to adjust at least one of a BT packet duration and a BT PDU size based on the recommended BT usage parameter.

7. The method of claim 1, further comprising determining the minimum bandwidth requirement of the WLAN module based on an activity level of traffic between the WLAN module and a second wireless device.

8. The method of claim 7, further comprising adjusting the recommended BT usage parameter based on the activity level of traffic between the WLAN module and the second wireless device.

9. The method of claim 8, wherein during a connection establishment of the WLAN module with the second wireless device, the recommended BT usage parameter comprises a BT packet duration that is shorter than a default BT packet duration of the BT module.

10. The method of claim 9, wherein during at least one of a high activity level and a critical activity level of traffic between the WLAN module and the second wireless device, the recommended BT usage parameter comprises a BT packet duration that is shorter than the default BT packet duration of the BT module.

11. The method of claim 10, wherein during a low activity level of traffic between the WLAN module and the second wireless device, the recommended BT usage parameter comprises the default BT packet duration of the BT module.

12. The method of claim 11, wherein the recommended BT usage parameter comprises the default BT packet duration of the BT module when the WLAN module is idle.

13. The method of claim 12, wherein the recommended BT usage parameter comprises the default BT packet duration of the BT module when the WLAN module is turned off.

14. The method of claim 13, wherein the default BT packet duration is one of approximately 17 milliseconds and approximately 4.5 milliseconds.

15. A wireless device, comprising:
a transceiver;
a memory; and
a processor communicatively coupled to the transceiver and the memory, the processor including:
a Wireless Local Area Network (WLAN) module configured to determine a recommended BT usage parameter based on a WLAN minimum bandwidth requirement,
a messaging interface configured to communicate the recommended BT usage parameter from the WLAN module to a Bluetooth (BT) module, and
the Bluetooth (BT) module configured to slice a BT packet based on the recommended BT usage parameter.

16. The wireless device of claim 15, wherein the recommended BT usage parameter comprises at least one of a BT packet duration and a BT protocol data unit (PDU) size.

17. The wireless device of claim 15, wherein the BT packet comprises a BT Low Energy (LE) long range coded physical layer (PHY) packet.

18. The wireless device of claim 15, wherein the BT module is configured to slice the BT packet into a plurality of smaller BT packets each having a PDU size appropriate for transmission within the recommended BT usage parameter.

19. The wireless device of claim 15, wherein the BT module is configured to transmit the recommended BT usage parameter to a second wireless device.

20. The wireless device of claim 19, wherein the BT module is configured to negotiate with the second wireless device to limit at least one of a BT packet duration and a BT PDU size based on the recommended BT usage parameter.

21. The wireless device of claim 15, wherein the WLAN module is configured to determine the minimum bandwidth requirement based on an activity level of traffic between the WLAN module and a second wireless device.

22. The wireless device of claim 21, wherein the WLAN module is configured to adjust the recommended BT usage parameter based on the activity level of traffic between the WLAN module and the second wireless device.

23. The wireless device of claim 22, wherein during a connection establishment of the WLAN module with the second wireless device, the recommended BT usage parameter comprises a BT packet duration that is shorter than a default BT packet duration of the BT module.

24. The wireless device of claim 23, wherein during at least one of a high activity level and a critical activity level of traffic between the WLAN module and the second wireless device, the recommended BT usage parameter comprises a BT packet duration that is shorter than the default BT packet duration of the BT module.

25. The wireless device of claim 24, wherein during a low activity level of traffic between the WLAN module and the second wireless device, the recommended BT usage parameter comprises the default BT packet duration of the BT module.

26. The wireless device of claim 25, wherein the recommended BT usage parameter comprises the default BT packet duration of the BT module when the WLAN module is idle.

27. The wireless device of claim 26, wherein the recommended BT usage parameter comprises the default BT packet duration of the BT module when the WLAN module is turned off.

28. The wireless device of claim 27, wherein the default BT packet duration is one of approximately 17 milliseconds and approximately 4.5 milliseconds.

29. An apparatus for wireless communication, comprising:
means for determining a recommended Bluetooth (BT) usage parameter based on a minimum bandwidth requirement of a Wireless Local Area Network (WLAN) module;
means for communicating the recommended BT usage parameter from the WLAN module to a BT module; and
means for slicing a BT packet based on the recommended BT usage parameter.

30. A non-transitory computer-readable storage medium storing instructions that, when executed by one or more processors of a wireless communications device, cause the wireless communications device to:
determine a recommended Bluetooth (BT) usage parameter based on a minimum bandwidth requirement of a Wireless Local Area Network (WLAN) module;
communicate the recommended BT usage parameter from the WLAN module to a BT module; and
slice a BT packet based on the recommended BT usage parameter.
